(19) United States
(12) Patent Application Publication
(10) Pub. No.: US 2023/0206783 A1
(43) Pub. Date: Jun. 29, 2023

(54) METHOD AND APPARATUS FOR ASSISTING THE DISABLED

(71) Applicants: Angel I. Sarat Lemus, Pembroke Pines, FL (US); LOCOMOTION TECHNOLOGIES CORP, Hollywood, FL (US); GLOBAL BIOLOGICS LLC, Miami, FL (US)

(72) Inventor: Angel I. Sarat Lemus, Pembroke Pines, FL (US)

(21) Appl. No.: 17/562,160

(22) Filed: Dec. 27, 2021

(51) Int. Cl. G09B 21/00; G06F 3/16; G06V 20/62; H04N 7/18; G10L 13/02; G10L 15/26; G10L 15/22; G07D 7/121; G01S 17/08; G06Q 20/02

(52) U.S. Cl. CPC G09B 21/006; G06F 3/167; G06V 20/63; H04N 7/183; G10L 13/02; G10L 15/26; G10L 15/22; G07D 7/121; G01S 17/08; G06Q 20/02

(57) ABSTRACT

A system for facilitating access for a disabled user includes a wrist-length glove configured for being worn over the user's hand and wrist, a LIDAR transmitter/receiver configured for emitting a laser light, receiving reflected laser light and calculating a range to objects that reflected the reflected laser light, wherein the LIDAR transmitter/receiver is removably coupled to a top of a wrist area of the glove, a mobile computing device and a mobile application for providing a text to speech program, a speech to text program, a money recognition system, a visual recognition system that detects scenes, and a proximity detection system that reads data from the LIDAR transmitter/receiver and produces speech that identifies the range to the objects that reflected the reflected laser light.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNICAL FIELD

The claimed subject matter relates to the field of accessibility for the disabled and, more specifically, the claimed subject matter relates to the field of mobile applications for assisting the disabled.

### BACKGROUND

Disability is defined by the World Health Organization (WHO) as any restriction or lack (result of a deficiency) of the ability to perform an activity, in the same form or degree that is considered normal for a human being. It is estimated that more than a billion people live with some type of disability; that is, about 15% of the world's population is disabled, according to world population estimates in 2010. People with disabilities face a number of difficulties that may exclude them from the rest of society. Among the most noted difficulties for the disabled are in the streets, public and private buildings, at work or at school. There are generally a lack of appropriate ramps for the disabled, public health services for the disabled, transportation with the required ramps, escalators, elevators and the like.

The (WHO) asserts that about 314 millions of people in the world live with visual impairment, due to eye diseases or refractive errors not corrected. In the Americas alone, it is estimated that for every million inhabitants there are 5,000 people with complete blindness and 20,000 people with some kind of visual impairment. This situation limits the ability of affected people to perform activities of daily living and deteriorates their quality of life. The difficulty of moving with autonomy and independence is one of the most common obstacles in people who suffer from blindness, in addition to problems at an emotional level, which difficulties can lead to social problems and problems at work.

Among the most common solutions to blindness are walking canes and guide dogs. These solutions, however, are sometimes insufficient as there is some information about the environment that the subject requires and the cane or guide dog are not able to grant. This shows the need to develop a solution to overcome the difficulties to which blind people are subjected, especially in open environments, so that it is possible to identify various types of obstacles that interfere with movement, as well as to determine the geographical information of the space in which they operate, so as to facilitate the orientation and mobility of people with this disability.

Therefore, what is needed is a system and method for improving the problems with the prior art, and more particularly for a more expedient and efficient method and system for providing accessibility for the disabled.

### BRIEF SUMMARY

In one embodiment, a system for facilitating access for a disabled user is disclosed. The system includes a wrist-length glove configured for being worn over the user's hand and wrist, a LIDAR transmitter/receiver configured for emitting a laser light, receiving reflected laser light and calculating a range to objects that reflected the reflected laser light, wherein the LIDAR transmitter/receiver is removably coupled to a top of a wrist area of the glove, a mobile computing device communicably connected to the LIDAR transmitter/receiver, the mobile computing device including a display, a microphone, a camera and a speaker, and a mobile application executing on the mobile computing device. The mobile application includes a first module configured for providing a text to speech program that converts text input by the user to speech output on the speaker, a second module configured for providing a speech to text program that converts speech input via the microphone to text on the display, a third module configured for providing a money recognition system that reads images of money input via the camera and produces speech output on the speaker that identifies said money, a fourth module configured for providing a visual recognition system that reads images of a scene input via the camera and produces speech output on the speaker that identifies said scene, and a fifth module configured for providing a proximity detection system that reads data from the LIDAR transmitter/receiver and produces speech that identifies the range to the objects that reflected the reflected laser light.

Additional aspects of the claimed subject matter will be set forth in part in the description which follows, and in part will be obvious from the description, or may be learned by practice of the claimed subject matter. The aspects of the claimed subject matter will be realized and attained by means of the elements and combinations particularly pointed out in the appended claims. It is to be understood that both the foregoing general description and the following detailed description are exemplary and explanatory only and are not restrictive of the disclosed subject matter, as claimed.

### BRIEF DESCRIPTION OF THE SEVERAL VIEWS OF THE DRAWINGS

The accompanying drawings, which are incorporated in and constitute part of this specification, illustrate embodiments of the claimed subject matter and together with the description, serve to explain the principles of the claimed subject matter. The embodiments illustrated herein are presently preferred, it being understood, however, that the claimed subject matter is not limited to the precise arrangements and instrumentalities shown, wherein:

FIG. 1A is a block diagram illustrating the network architecture of a system for providing accessibility for the disabled over a communications network, in accordance with one embodiment.

FIG. 1B is an illustration depicting a proximity detection system used with a system for providing accessibility for the disabled over a communications network, in accordance with one embodiment.

FIG. 2 is a block diagram showing the data flow of the process for providing accessibility for the disabled over a communications network, according to one embodiment.

FIG. 3 is a flow chart depicting the general control flow of a process for providing accessibility for the disabled over a communications network, according to one embodiment.

FIG. 4 is a block diagram depicting a system including an example computing device and other computing devices.

### DETAILED DESCRIPTION

The following detailed description refers to the accompanying drawings. Wherever possible, the same reference numbers are used in the drawings and the following description to refer to the same or similar elements. While embodiments may be described, modifications, adaptations, and other implementations are possible. For example, substitutions, additions, or modifications may be made to the elements illustrated in the drawings. Likewise, the methods described herein may be modified by substituting, reordering, or adding stages to the disclosed methods. Accordingly, the following detailed description does not limit the claimed subject matter. Instead, the proper scope of the claimed subject matter is defined by the appended claims.

The disclosed embodiments improve upon the problems with the prior art by providing a system that facilitates mobility of a disabled or blind person by providing information about the world around him or her. The claimed embodiments include a systems for recognizing and detecting obstacles, and notifying the user of said obstacles, thereby providing the user with autonomy and independence in movement. Therefore, the disclosed embodiments reduce or eliminate the possibility of accidents or incursions with obstacles for the disabled or blind user period. This is advantageous for users, as it overcomes standard obstacles faced by the disabled or the blind in mov. An additional benefit of the disclosed embodiments is the text to speech and speech to text systems, which allows the user to communicate with others when there is difficulty using voice or audio communications. A further benefit of the disclosed embodiments is the money recognition and scene recognition systems, which allows the user to detect and identify money, notes or coins, and the scene around him or her, allowing the user to have more information about the world around him or her period. The main benefit of the claimed subject matter is the improvement of the lives of disabled users by augmenting the information they receive about the world around them.

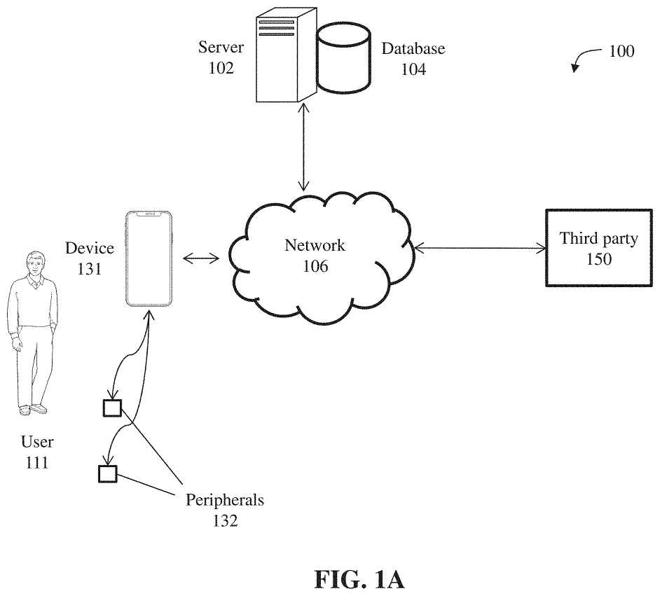

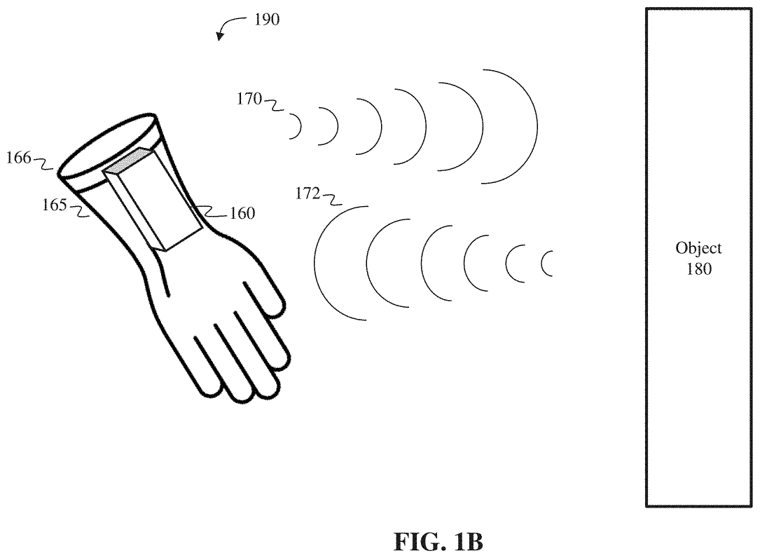

Referring now to the drawing figures in which like reference designators refer to like elements, there is shown in FIG. 1A an illustration of a block diagram showing the network architecture of a system 100 and method for facilitating accessibility for the disabled over a communications network in accordance with one embodiment. FIG. 1A shows the server 102 associated with repository or database 104 and further communicatively coupled with network 106, which can be a circuit switched network, such as the Public Service Telephone Network (PSTN), or a packet switched network, such as the Internet or the World Wide Web, the global telephone network, a cellular network, a mobile communications network, or any combination of the above. Server 102 is a central controller or operator for functionality of the disclosed embodiments, namely, facilitating accessibility for the disabled.

FIG. 1A includes mobile computing device 131, which may be smart phones, mobile phones, tablet computers, handheld computers, laptops, or the like. In another embodiment, mobile computing device 131 may be workstations, desktop computers, servers, laptops, all-in-one computers, or the like. In another embodiment, mobile computing device 131 may be AR or VR systems that may include display screens, headsets, heads up displays, helmet mounted display screens, tracking devices, tracking lighthouses or the like. Mobile computing device 131 corresponds to a customer or user 111 of the system 100 for facilitating accessibility for the disabled. FIG. 1A also shows a server, computer, or mobile computing device 150 corresponding to a third party, such as a person or persons. Devices 102, 131, 150 may be communicatively coupled with network 106 in a wired or wireless fashion. Augmented reality (AR) adds digital elements to a live view often by using a camera on a computing device. Virtual reality (VR) is a complete or near complete immersion experience that replaces the physical world.

FIG. 1A further shows that server 102 includes a database or repository 104, which may be a relational database comprising a Structured Query Language (SQL) database stored in a SQL server. Devices 131, 150 may also each include their own database. The repository 104 serves data from a database, which is a repository for data used by server 102 and devices 131, 150 during the course of operation of the disclosed embodiments. Database 104 may be distributed over one or more nodes or locations that are connected via network 106.

The database 104 may include a user record for each user 111. A user record may include: contact/identifying information for the user (name, address, telephone number(s), email address, etc.), information pertaining to disabilities associated with the user, contact/identifying information for friends of the user, electronic payment information for the user, information pertaining to the places visited by the user, sales transaction data associated with the user, etc. A user record may also include a unique identifier for each user, a residential address for each user, the current location of each user (based on location-based services from the user's mobile computer) and a description of past text and speech entered by each user. A user record may further include demographic data for each user, such as age, sex, income data, race, color, marital status, etc. A user record may also include contact information (email address, name, address, telephone number, etc.) or a unique identifier for one or more friends or acquaintances of the user.

Sales transaction data may include one or more product/service identifiers (such as SKUs), one or more product/service amounts, buyer contact/identifying information, brick and mortar outlet information, and electronic payment information. In one embodiment, electronic payment information may comprise buyer contact/identifying information and any data garnered from a purchase card (i.e., purchase card data), as well as any authentication information that accompanies the purchase card. Purchase card data may comprise any data garnered from a purchase card and any authentication information that accompanies the purchase card. In one embodiment, electronic payment information may comprise user login data, such as a login name and password, or authentication information, which is used to access an account that is used to make a payment.

FIG. 1A shows an embodiment wherein networked computing devices 131, 150 interact with server 102 and repository 104 over the network 106. It should be noted that although FIG. 1A shows only the networked computers 131, 150 and 102, the system of the disclosed embodiments supports any number of networked computing devices connected via network 106. Further, server 102, and items 131, 150 include program logic such as computer programs, mobile applications, executable files or computer instructions (including computer source code, scripting language code or interpreted language code that may be compiled to produce an executable file or that may be interpreted at run-time) that perform various functions of the disclosed embodiments.

Note that although server 102 and device 131 are shown as single and independent entities, in one embodiment, the functions of server 102 and device 131 may be integrated with another entity, such as one of the devices 150. Further, server 102 and device 121 and their functionality, according to a preferred embodiment, can be realized in a centralized fashion in one computer system or in a distributed fashion wherein different elements are spread across several interconnected computer systems.

FIG. 1A also shows one or more peripherals 132 connected to device 131, which peripherals may be an auxiliary device used to put information into and get information out of device 131, and may include hardware components that are attached to device 131 and are controlled by device 131. Said peripherals may be an input device that sends data or instructions to the device 131, such as a mouse, keyboard, graphics tablet, image scanner, barcode reader, game controller, light pen, light gun, microphone, camera, and webcam, or an output device that provides output data from the device 131, such as a computer monitor, display, projector, printer, headphones, and speaker. Said peripherals may also be an input/output device that performs both input and output functions, such as a computer data storage device (including a disk drive, solid-state drive, USB flash drive, memory card and tape drive), network adapter and multi-function printer. Peripherals 132 may also be a detection system 190, explained in greater detail below.

FIG. 1B is an illustration depicting a proximity detection system 190 used with the system 100 for providing accessibility for the disabled over a communications network 106, in accordance with one embodiment. The proximity detection system 190 comprises a wrist length glove 166 that is configured to be worn over the hand and wrist of the user 111. The proximity detection system 190 further comprises a LIDAR system 160 configured to be removably attached to a wrist portion 165 of the glove 166. A haptic feedback system may also be included in the glove 165 or system 160.

LIDAR is a method for determining ranges (variable distance) by targeting an object with a laser and measuring the time for the reflected light to return to the receiver. LIDAR can also be used to make digital 3-D representations of areas and scenes or locations, due to differences in laser return times, and by varying laser wavelengths. LIDAR is also referred to as light detection and ranging, laser imaging, detection, and ranging and 3-D laser scanning. LIDAR uses ultraviolet, visible, or near infrared light to image areas and scenes or locations. A narrow laser beam can map physical features with very high resolutions. Wavelengths vary to suit the target. Light may be reflected via backscattering, or pure reflection. Different types of scattering are used for different LIDAR applications: most commonly Rayleigh scattering, Mie scattering, Raman scattering, and fluorescence.

The two kinds of LIDAR detection schemes are “incoherent” or direct energy detection, that principally measures amplitude changes of the reflected light, and coherent detection that measures Doppler shifts, or changes in the phase of the reflected light. LIDAR systems consist of several major components, including the laser, such as 600-1000 nm lasers, phased arrays, which can illuminate any direction by using a microscopic array of individual antennas, microelectromechanical mirrors for transmitting the lasers or light, scanners/optics for collecting return signals, photodetectors and receiver electronics for collecting reflected lasers and light, position and navigation systems for determining current geographical position, and sensors for detecting the reflected light or lasers.

The LIDAR system 160 emits lasers 170, light or other energy sources that hit an object 180 and the reflected lasers 172, light or energy is detected and measured by the sensors. Distance to the object 180 is determined by recording the time between transmitted and reflected energy or light and by using the speed of light to calculate the distance traveled.

As explained more fully below, the claimed embodiments include a text to speech system and a speech to text system. A text to speech, or speech synthesis, system is a computer system that performs the artificial production of human speech, wherein normal language text is converted into speech. Synthesized speech can be created by concatenating pieces of recorded speech that are stored in a database. Alternatively, a synthesizer can incorporate a model of the vocal tract and other human voice characteristics to create a completely synthetic voice output. A text-to-speech system is composed of two parts: a front-end and a back-end. The front-end has two major tasks. First, it converts raw text containing symbols like numbers and abbreviations into the equivalent of written-out words. This process is often called text normalization, pre-processing, or tokenization. The front-end then assigns phonetic transcriptions to each word, and divides and marks the text into prosodic units, like phrases, clauses, and sentences. The back end then converts the symbolic linguistic representation into sound.

A speech to text, or speech recognition, system is a computer system that converts human speech to normal language text. Speech recognition is an interdisciplinary subfield of computer science and computational linguistics that develops methodologies and technologies that enable the recognition and translation of spoken language into text by computers. A speech recognition system listens to speech that is spoken by a human and using methods for recognizing the words that are being spoken, produces normal language text that corresponds to the words spoken.

As explained more fully below, the claimed embodiments include a currency or money recognition system. A currency or money recognition system is a computer system that determines the identity, type, and value of notes or coins. A currency or money recognition system utilizes a process that involves examining the coins and/or notes that have been presented, and conducts various processes to determine the identity, type, and value of notes or coins. Optical sensing with a small light detector called a photocell or a miniature digital camera is one known technique for determining the identity, type, and value of notes or coins. The optical sensors can look for different patterns to determine the identity, type, and value of notes or coins. Object recognition is another known technique for determining the identity, type, and value of notes or coins. Object recognition is a technology in the field of computer vision for finding and identifying objects in an image or video sequence. An object recognition process can look for certain numbers, graphics, and patterns to determine the identity, type, and value of notes or coins.

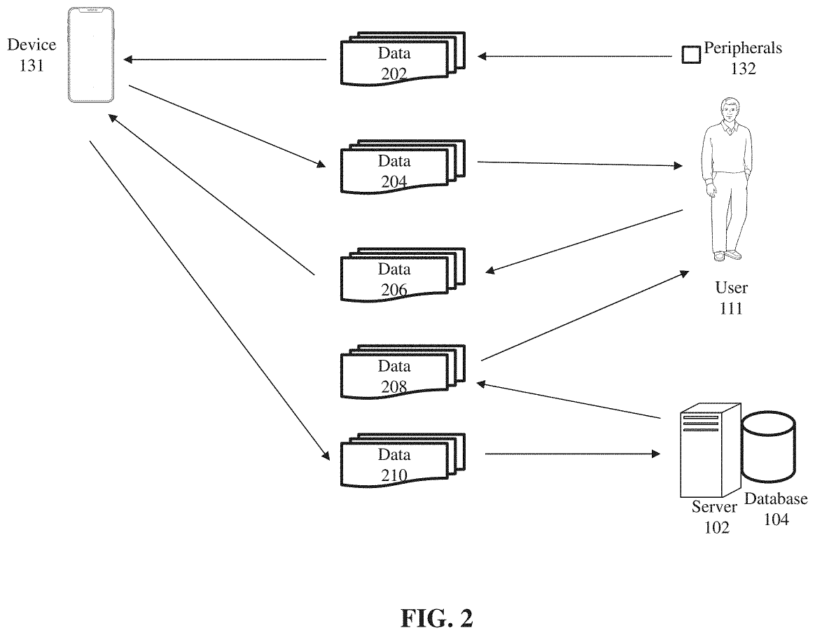

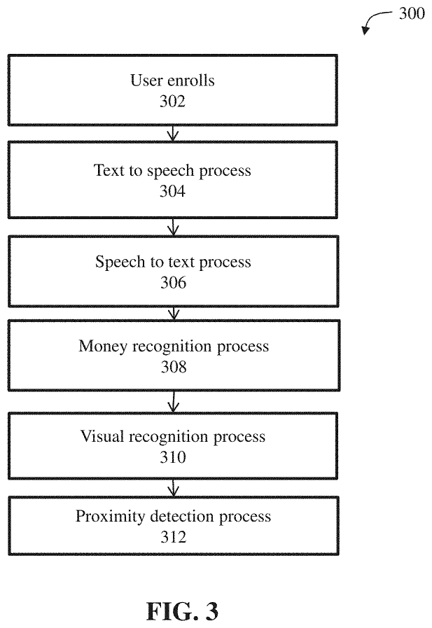

The process of facilitating accessibility for the disabled over a communications network will now be described with reference to FIGS. 2-3 below. FIGS. 2-3 depict the data flow and control flow of the process for facilitating accessibility for the disabled over a communications network 106, according to one embodiment. The process of the disclosed embodiments begins with optional step 302 (see flowchart 300), wherein the user 111 may enroll or register with server 102. In the course of enrolling or registering, the user may enter data into their device 131 by manually entering data into a mobile application via keypad, touchpad, or via voice. In the course of enrolling or registering, the user may enter any data that may be stored in a user record, as defined above. Also in the course of enrolling or registering, the server 102 may generate a user record for each registering user and store the user record in an attached database, such as database 104.

Subsequently, in step 304, a first module on device 131 provides a text to speech program that converts text input by the user (data 202) to speech output on the speaker (data 204). The text may be input by the user into the device 131 via touchscreen, microphone, or the like. Said text may also be received by the device 131 via network 106, such as via text message, via email or via a mobile application. In step 306, a second module on device 131 provides a speech to text program that converts speech input via the microphone (data 202) to text on the display (data 204). The speech may be input by the user into the device 131 via microphone or the like. Said speech may also be received by the device 131 via network 106, such as via text message, via email or via a mobile application.

In step 308, a third module on device 131 provides a money recognition system that reads images of money (data 202) input via the camera and produces speech output on the speaker (data 204) that identifies said money. The images may be input by the user into the device 131 via a camera or the like. Said images may also be received by the device 131 via network 106, such as via text message, via email or via a mobile application.

In step 310, a fourth module on device 131 provides a visual recognition system that reads images of a scene input via the camera (data 202) and produces speech output on the speaker (data 204) that identifies said scene. The images may be input by the user into the device 131 via a camera or the like. Said images may also be received by the device 131 via network 106, such as via text message, via email or via a mobile application. The visual recognition system may comprise a computer enabled object recognition system.

In one embodiment, the fourth module operates as follows. First, images of a scene are input via the camera as data 206. Next, the device 131 sends said images as data 210 to the server 102. Subsequently, the server 102 sends said to a third party 150 over network 106. then, the third-party person reviews the images and provides speech output that describes or identifies said scene. Said speech is transmitted from the third party 150 over network 106 to the server 102. Then, the server 102 sends said speech as data 208 to the device 131 of user 111 via the network 106. Said speech is then output on the speaker of device 131.

In step 312, a fifth module on device 131 provides a proximity detection system 190 that reads data from a LIDAR transmitter/receiver 160 and produces speech that identifies the range to objects 180 that reflected the reflected laser light. Ranges may be provided to the user 111 via speech output on the speaker, text output on the display, or via haptic feedback on the glove 166 or device 160. The LIDAR transmitter/receiver emits a laser light, receives reflected laser light reflected from objects 180 and calculates a range to the objects that reflected the laser light.

In one embodiment, the claimed embodiments include a system that provides cryptocurrency to the user 111. A cryptocurrency is a collection of binary data which is designed to work as a medium of exchange. Individual coin ownership records are stored in a distributed ledger, which is a computerized database using strong cryptography to secure transaction records, to control the creation of additional coins, and to verify the transfer of coin ownership. The validity of each cryptocurrency's coins is provided by a blockchain. A blockchain is a continuously growing list of records, called blocks, which are linked and secured using cryptography. In cryptocurrency networks, mining is a validation of transactions. For this effort, successful miners obtain new cryptocurrency as a reward.

In one embodiment, the claimed embodiments include a system that provides cryptocurrency to the user 111 through mining, wherein certain events trigger mining transactions. Said events include interactions between the user 111 and the mobile application executing on the device 131, and/or the server 102, interactions between the proximity detection system 190 (or peripherals 132) and the mobile application executing on the device 131, and/or the server 102, interactions between third party devices (such as devices operating in the public) and the mobile application executing on the device 131, and/or the server 102. Said events would be detected by the mobile application executing on the device 131, and/or the server 102, and the server 102 would respond by issuing cryptocurrency to the user 111 or in the user's name.

Recall that the claimed embodiments may include an application executing on a computing device (or server 102), the application comprising a first module configured for providing a text to speech program that converts text input by the user to speech output on the speaker; a second module configured for providing a speech to text program that converts speech input via the microphone to text on the display; a third module configured for providing a money recognition system that reads images of money input via the camera and produces speech output on the speaker that identifies said money; a fourth module configured for providing a visual recognition system that reads images of a scene input via the camera; transmitting, via the communications network, the images of a scene to a second user; receiving, via the communications network, speech from the second user that identifies said scene; and outputting said speech from the second user on the speaker; and a fifth module configured for providing a proximity detection system that reads data from the LIDAR transmitter/receiver and produces speech that identifies the range to the objects that reflected the reflected laser light.

In one embodiment, the system that provides cryptocurrency to the user 111 through mining operates as follows. The application executing on the mobile computing device (or server 102) is configured for detecting actions performed by the first module, the second module, the third module, the fourth module, and the fifth module; evaluating an amount of actions taken by the first module, the second module, the third module, the fourth module, and the fifth module; calculating an amount of cryptocurrency corresponding to the amount of actions taken by the first module, the second module, the third module, the fourth module, and the fifth module; transmitting, via the communications network, a request to a third-party node to issue said amount of cryptocurrency to the user.

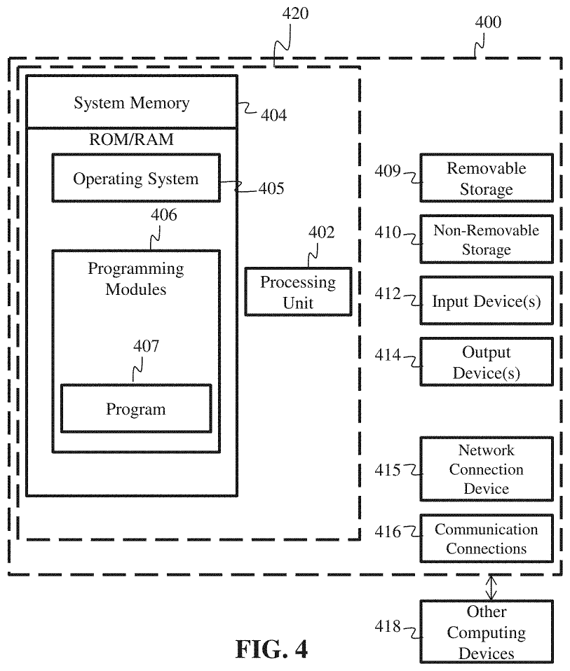

FIG. 4 is a block diagram of a system including an example computing device 400 and other computing devices. Consistent with the embodiments described herein, the aforementioned actions performed by items 102, 131, 132 may be implemented in a computing device, such as the computing device 400 of FIG. 4. Any suitable combination of hardware, software, or firmware may be used to implement the computing device 400. The aforementioned system, device, and processors are examples and other systems, devices, and processors may comprise the aforementioned computing device. Furthermore, computing device 400 may comprise an operating environment for system 100 and process 300, as described above. Process 300 may operate in other environments and are not limited to computing device 400.

With reference to FIG. 4, a system consistent with an embodiment may include a plurality of computing devices, such as computing device 400. In a basic configuration, computing device 400 may include at least one processing unit 402 and a system memory 404. Depending on the configuration and type of computing device, system memory 404 may comprise, but is not limited to, volatile (e.g. random-access memory (RAM)), non-volatile (e.g. read-only memory (ROM)), flash memory, or any combination or memory. System memory 404 may include operating system 405, and one or more programming modules 406. Operating system 405, for example, may be suitable for controlling computing device 400's operation. In one embodiment, programming modules 406 may include, for example, a program module 407 for executing the actions of items 102, 131, 132. Furthermore, embodiments may be practiced in conjunction with a graphics library, other operating systems, or any other application program and is not limited to any particular application or system. This basic configuration is illustrated in FIG. 4 by those components within a dashed line 420.

Computing device 400 may have additional features or functionality. For example, computing device 400 may also include additional data storage devices (removable and/or non-removable) such as, for example, magnetic disks, optical disks, or tape. Such additional storage is illustrated in FIG. 4 by a removable storage 409 and a non-removable storage 410. Computer storage media may include volatile and nonvolatile, removable and non-removable media implemented in any method or technology for storage of information, such as computer readable instructions, data structures, program modules, or other data. System memory 404, removable storage 409, and non-removable storage 410 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 400. Any such computer storage media may be part of device 400. Computing device 400 may also have input device(s) 412 such as a keyboard, a mouse, a pen, a sound input device, a microphone, a camera, a touch input device, etc. Output device(s) 414 such as a display, speakers, a printer, etc. may also be included. Computing device 400 may also include a vibration device capable of initiating a vibration in the device on command, such as a mechanical vibrator or a vibrating alert motor. The aforementioned devices are only examples, and other devices may be added or substituted. Computing device 400 may also include an accelerometer for detecting acceleration, a GPS chip for calculating geographical position, a Bluetooth chip for RF communications over short distances and a Wi-Fi chip for RF communications over short distances.

Computing device 400 may also contain a network connection device 415 that may allow device 400 to communicate with other computing devices 418, such as over a network in a distributed computing environment, for example, an intranet or the Internet. Device 415 may be a wired or wireless network interface controller, a network interface card, a network interface device, a network adapter or a LAN adapter. Device 415 allows for a communication connection 416 for communicating with other computing devices 418. Communication connection 416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, a number of program modules and data files may be stored in system memory 404, including operating system 405. While executing on processing unit 402, programming modules 406 (e.g. program module 407) may perform processes including, for example, one or more of the stages of the process 300 as described above. The aforementioned processes are examples, and processing unit 402 may perform other processes. Other programming modules that may be used in accordance with embodiments herein may include electronic mail and contacts applications, word processing applications, spreadsheet applications, database applications, slide presentation applications, drawing or computer-aided application programs, etc.

Generally, consistent with embodiments herein, program modules may include routines, programs, components, data structures, and other types of structures that may perform particular tasks or that may implement particular abstract data types. Moreover, embodiments herein may be practiced with other computer system configurations, including hand-held devices, multiprocessor systems, microprocessor-based or programmable consumer electronics, minicomputers, mainframe computers, and the like. Embodiments herein may also be practiced in distributed computing environments where tasks are performed by remote processing devices that are linked through a communications network. In a distributed computing environment, program modules may be located in both local and remote memory storage devices.

Furthermore, embodiments herein may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments herein may also be practiced using other technologies capable of performing logical operations such as, for example, AND, OR, and NOT, including but not limited to mechanical, optical, fluidic, and quantum technologies. In addition, embodiments herein may be practiced within a general purpose computer or in any other circuits or systems.

Embodiments herein, for example, are described above with reference to block diagrams and/or operational illustrations of methods, systems, and computer program products according to said embodiments. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments have been described, other embodiments may exist. Furthermore, although embodiments herein have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the claimed subject matter.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A system for facilitating access for a disabled user, the system comprising:
a) a wrist-length glove configured for being worn over the user's hand and wrist;
b) a LIDAR transmitter/receiver configured for emitting a laser light, receiving reflected laser light, and calculating a range to objects that reflected the reflected laser light, wherein the LIDAR transmitter/receiver is removably coupled to a top of a wrist area of the glove;
c) a mobile computing device communicably connected to the LIDAR transmitter/receiver, the mobile computing device including a display, a microphone, a camera, and a speaker;
d) a mobile application executing on the mobile computing device, the mobile application comprising:
1) a first module configured for providing a text to speech program that converts text input by the user to speech output on the speaker;
2) a second module configured for providing a speech to text program that converts speech input via the microphone to text on the display;
3) a third module configured for providing a money recognition system that reads images of money input via the camera and produces speech output on the speaker that identifies said money;
4) a fourth module configured for providing a visual recognition system that reads images of a scene input via the camera and produces speech output on the speaker that identifies said scene; and
5) a fifth module configured for providing a proximity detection system that reads data from the LIDAR transmitter/receiver and produces speech that identifies the range to the objects that reflected the reflected laser light.

2. The system of claim 1, wherein the first module is further configured for providing a text to speech program that converts text input by the user, via a user interface on the mobile computing device, to speech output on the speaker.

3. The system of claim 2, wherein the second module is further configured for providing a speech to text program that converts speech, received via the mobile computing device, to text on the display.

4. The system of claim 3, wherein the third module is further configured for providing a money recognition system that reads images of money, received via the mobile computing device, and produces speech output on the speaker that identifies said money.

5. The system of claim 4, wherein the fourth module is further configured for providing a visual recognition system that reads images of a scene, received via the mobile computing device, and produces speech output on the speaker that identifies said scene.

6. The system of claim 5, wherein the fifth module is further configured for providing a proximity detection system that reads data from the LIDAR transmitter/receiver and text on the display that identifies the range to the objects that reflected the reflected laser light.

7. The system of claim 6, wherein the fourth module is further configured for:
transmitting, via a communications network, the images of a scene to a second user;
receiving, via the communications network, speech from the second user that identifies said scene; and
outputting said speech from the second user on the speaker.

8. A system for facilitating access for a disabled user, the system comprising:
a) a wrist-length glove configured for being worn over the user's hand and wrist;
b) a LIDAR transmitter/receiver configured for emitting a laser light, receiving reflected laser light, and calculating a range to objects that reflected the reflected laser light, wherein the LIDAR transmitter/receiver is removably coupled to a top of a wrist area of the glove;
c) a mobile computing device communicably connected to the LIDAR transmitter/receiver, the mobile computing device including a display, a microphone, a camera and a speaker, the mobile computing device further communicably connected to a communications network;
d) a mobile application executing on the mobile computing device, the mobile application comprising:
1) a first module configured for providing a text to speech program that converts text input by the user to speech output on the speaker;
2) a second module configured for providing a speech to text program that converts speech input via the microphone to text on the display;
3) a third module configured for providing a money recognition system that reads images of money input via the camera and produces speech output on the speaker that identifies said money;
4) a fourth module configured for:
providing a visual recognition system that reads images of a scene input via the camera;
transmitting, via the communications network, the images of a scene to a second user;
receiving, via the communications network, speech from the second user that identifies said scene; and
outputting said speech from the second user on the speaker; and
5) a fifth module configured for providing a proximity detection system that reads data from the LIDAR transmitter/receiver and produces speech that identifies the range to the objects that reflected the reflected laser light.

9. The system of claim 8, wherein the first module is further configured for providing a text to speech program that converts text input by the user, via a user interface on the mobile computing device, to speech output on the speaker.

10. The system of claim 9, wherein the second module is further configured for providing a speech to text program that converts speech, received via the mobile computing device, to text on the display.

11. The system of claim 10, wherein the third module is further configured for providing a money recognition system that reads images of money, received via the mobile computing device, and produces speech output on the speaker that identifies said money.

12. The system of claim 11, wherein the fourth module is further configured for providing a visual recognition system that reads images of a scene, received via the mobile computing device, and produces speech output on the speaker that identifies said scene.

13. The system of claim 12, wherein the fifth module is further configured for providing a proximity detection system that reads data from the LIDAR transmitter/receiver and text on the display that identifies the range to the objects that reflected the reflected laser light.

14. The system of claim 13, further comprising a sixth module configured for:
detecting actions performed by the first module, the second module, the third module, the fourth module, and the fifth module;
evaluating an amount of actions taken by the first module, the second module, the third module, the fourth module, and the fifth module;
calculating an amount of cryptocurrency corresponding to the amount of actions taken by the first module, the second module, the third module, the fourth module, and the fifth module;
transmitting, via the communications network, a request to a third-party node to issue said amount of cryptocurrency to the user.
